(19) United States
(12) Patent Application Publication
(10) Pub. No.: US 2010/0118553 A1
(43) Pub. Date: May 13, 2010

(54) LINKAGE MEMBERS METHODS OF PROTECTING LAMPS AND LAMPS

(76) Inventor: David Charles Payne, Norfolk (GB)

Correspondence Address: Workman Nydegger;1000 Eagle Gate Tower, 60 East South Temple, Salt Lake City, UT, 84111, US

(21) Appl. No.: 12/597,633

(22) PCT Filed: Apr. 25, 2008
(86) PCT No.: PCT/GB08/01468

§ 371 Date: Oct. 26, 2009

(30) Foreign Application Priority Data
Apr. 27, 2007 (GB) 0708149.0

(51) Int. Cl. F21V 15/00; B05D 5/00

(52) U.S. Cl. 362/377; 427/64

(57) ABSTRACT

A linkage member to link lamps; said lamps being of the kind which comprise electrical contact points located at their first end and no external electrical contact points at their second end; said linkage member comprises a first portion configured to attach to the electrical contact points of a first lamp and to cover at least in part said electrical contact points; and a second portion configured to connect to a second lamp at an end which has no external electrical contact points.

### FIELD OF THE INVENTION

The invention relates to linkage members, methods of protecting lamps and lamps.

### BACKGROUND TO THE INVENTION AND PRIOR ART KNOWN TO THE APPLICANT(S)

The closest prior art is the applicant's own prior published patent document EP1320417 by Fotolec Technologies Plc which discloses methods of coating fluorescent lamp tubes with linkage members joining the tubes temporarily during the coating process.

The prior art linkage members may come in various shapes such as cylindrical, square, hexagonal and octagonal. The linkage members secure adjacent tubular lamps in order to cover exposed electrical contact points which are provided at both ends of the tubular lamps. The linkage members therefore have for example rectangular recesses and cylindrical recesses allowing the electrical contact points to fit tightly in order to join adjacent lamps together.

The prior art method also envisages separating the linkage member from the lamp once it is coated. The lamps would simply not be able to work if the linkage members were not removed.

A number of lamps exist which incorporate electrical contact points on only one side of the lamp with their opposite end being free of any electrical contact points. One of the problems which the invention solves is how to link a succession of lamps which are of this kind. Another problem which the invention addresses is to how to protect the end of a lamp which has no electrical contact points. Another problem which the invention addresses is to reduce the steps required for preparing coated lamps.

### SUMMARY OF THE INVENTION

In a first broad independent aspect, the invention provides a linkage member to link lamps; said lamps being of the kind which comprise electrical contact points located at their first end and no external electrical contact points at their second end; said linkage member comprising a first portion configured to attach to the electrical contact points of a first lamp and to cover at least in part said electrical contact points; and a second portion configured to connect to a second lamp at an end which has no external electrical contact points.

This configuration is particularly advantageous because it allows a succession of lamps of the kind in question to be joined together for the coating process. It also allows the protection of the relatively brittle free end of the lamps of the kind in question. It also avoids having to crimp the ends of the coating about the free ends of the lamps.

In a further subsidiary aspect, said first portion incorporates one or more recesses configured to tightly fit onto one or more electrical contact points formed as projections. This allows the linkage member to be tightly fitted which avoids the risk of accidentally losing an end linkage member when connecting a succession of linkage members together.

In a further subsidiary aspect, said second portion incorporates one or more recesses configured to tightly fit onto a second lamp at an end which has no external electrical contact points. This configuration allows the linkage member to be simply slotted onto the free end of the lamps. It is relatively simple to operate by simply placing the linkage member onto the lamp. There are no complex actuators to trigger.

In a further subsidiary aspect, the linkage member is shaped and configured to connect to PLL lamps by push-fit means. This configuration is particularly advantageous because it allows such lamps to be coated as a succession of lamps.

In a further subsidiary aspect, said second portion incorporates two recesses which are shaped and configured to receive the two tube ends of a PLL lamp (the term “PLL” is a standard one in this field). This configuration allows the free extremity of the lamps to be accurately located into the linkage member and therefore it allows the linkage member to be secured in an improved manner.

In a further subsidiary aspect, the linkage member is inherently flexible in order to be secured to a variety of lamp sizes.

In a second broad independent aspect, the invention provides a method of protecting lamps comprising the steps of linking a succession of lamps being of the kind which comprise electrical contact points located at their first end and no external electrical contact points at their second end by placing one or more linkage members according to the first aspect between lamps; submitting said lamps to a station for the application of a shatter resistant or containing protective layer of materials; separating adjacent lamps after application of said protective layer of material; and retaining said linkage member on the second end of said lamps.

This configuration is particularly advantageous because it removes the prior art requirement of removing the linkage member. It achieves the finished protected lamp in a reduced number of method steps whilst improving the end protection for lamps of the kind in question.

In a subsidiary aspect in accordance with the second broad independent aspect, said lamps incorporate two or more adjacent tubes with one or more gaps between said tubes and said method further comprises the step of placing a support member in at least a portion of said gaps between said tubes. This method minimises or does entirely away with any risk of breakage during the coating process. It is particularly beneficial in terms of distribution of stresses and strains in lamps with multiple adjacent tubes.

In a third broad independent aspect, the invention provides a lamp comprising electrical contact points located at its first end and no external electrical contact points at its second end; a shatter resistant or containing protective layer of material enveloping said lamps; and a protective cap which is connected to the end of the lamp which has no external electrical contact points; wherein said protective layer extends at least over a portion of said protective cap.

This configuration is particularly advantageous because it allows the protective coating to assist in securing the protective cap onto the lamp. It also provides a lamp whose extremities are both protected. It would therefore reduce any risk of damage when stacking the finished lamps or when accidentally impacting on the free extremity of the lamp of the kind in question.

In a subsidiary aspect in accordance with the invention's third broad independent aspect, said lamp incorporates two or more adjacent tubes with one or more gaps between said tubes and a support member is provided between two or more tubes in at least a portion of said gaps. This configuration is particularly advantageous because it allows the coating process to occur with minimal or no breakage at all. It reduces the stresses and strains at certain locations of a lamp during the manufacturing process.

### BRIEF DESCRIPTION OF THE FIGURES

FIG. 1 shows a PLL lamp in plan view which is equipped at its free extremity with a protective cap.

FIG. 2 shows respectively the protective cap from the free extremity receiving portion (FIG. 2A) and from the portion for receiving multiple electrical contact points (FIG. 2B).

FIG. 3 shows a cross-sectional view of the protective cap of FIG. 2.

FIG. 4 shows a perspective view of a further embodiment of a protective cap from its free extremity of a lamp receiving portion.

FIG. 5 shows a protective cap in accordance with a further embodiment of the invention.

FIG. 6 shows the free extremity of the lamp with a protective cap and its coating layer.

FIG. 7 shows an upper elevation of a portion of a PLL lamp with a support member.

FIGS. 8a to 8e show a variety of support members in cross-sectional view. FIG. 8f shows a support member in part cross-sectional view and part perspective view.

FIG. 8g shows a further support member in perspective view.

### DETAILED DESCRIPTION OF THE FIGURES

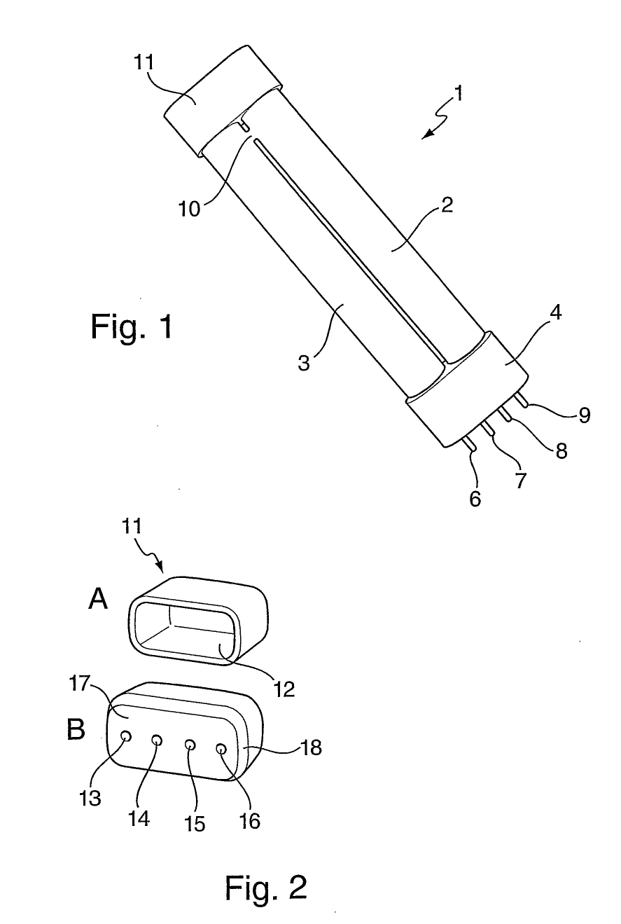

FIG. 1 shows a PLL lamp with two parallel glass tubes 2 and 3 projecting from an electrical contact point housing 4. Four electrical contact points 6, 7, 8 and 9 project in the opposite direction to the glass tubes from housing 4. A relatively weak joint joins the glass tubes 2 and 3 together which is referenced 10. A protective cap or linkage member is secured by placing it on top of the free extremity of the lamp. The linkage member or protective cap is referenced 11. It is preferably of a UV resistant polymeric material which is capable of withstanding the temperatures at which these lamps operate. A preferred material would be polybutylene terephthalate (PBT). Another possible category of material would be nylon. The protective cap would preferably be of a solid colour and of a thickness and material which allows the cap to be sufficiently flexible to fit to varying sizes of lamps. The material may be chosen so that it may readily be manually extendible by upto 10% in order to elastically return to clamp onto the free extremity of a lamp of the kind in question.

The protective cap generally referenced 11 incorporates a first side with a portion configured to connect to the free end of a lamp which has no electrical contact points. This portion incorporates a recess 12. The surfaces of the inside of the recess are smooth in this embodiment. The recess has a stretched oval shape in order to be able to accommodate both tubular end portions of the lamp.

The opposite end of the protective cap is shown in FIG. 2B where a number of blind holes 13, 14, 15 and 16 are envisaged which are sized and shaped to tightly fit onto the projecting electrical contact points 6, 7, 8 and 9 of the lamp of FIG. 1. The protective cover incorporates a chamfer 18 extending around face 17.

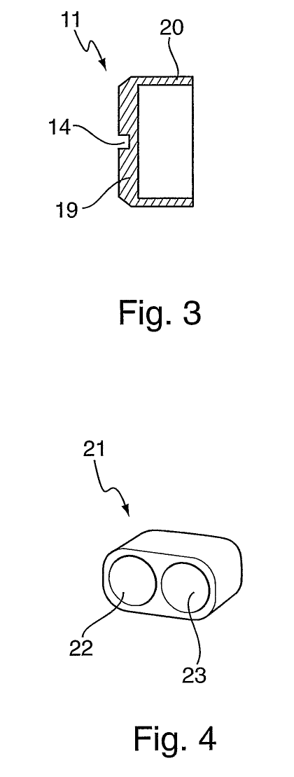

FIG. 3 shows the linkage member or protective cap 11 in cross-section passing through blind hole 14. The base 19 of the protective cap is of greater thickness than the side wall 20. The relative thickness of the side wall and the base 19 achieves some flexibility for securing the protective cap onto the free end of a lamp.

FIG. 4 shows a further linkage member or protective cap generally referenced 21 which instead of a single recess 12 incorporates two recesses 22 and 23 side by side for receiving individual ends of tubes. The opposite side of the protective cap may be of the kind shown in FIG. 2 with a plurality of recesses corresponding to electrical contact points.

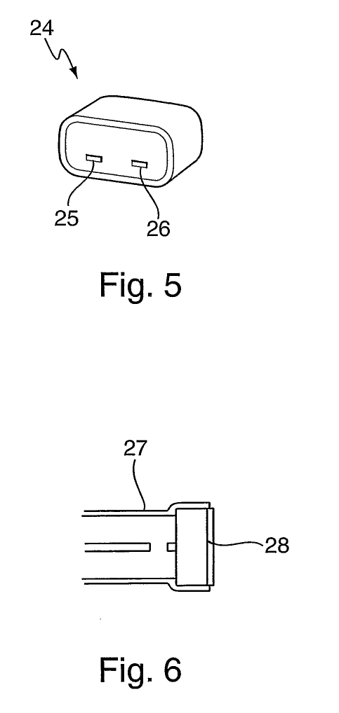

FIG. 5 shows a further protective cap or linkage member generally referenced 24 with two distinct regions 25 and 26 which may have a relatively high friction coefficient compared to the rest of the inside surface of the cap. Alternatively, regions 25 and 26 may incorporate a projection in order to exercise grip on the free end of the lamp in order to secure it in position. The side edges of the protective cap are preferably rounded in order to minimise sharp edges.

EP1320417 describes a method which may be used to coat a lamp to render it shatter containing. This application discloses an improved method where a number of PLL lamps are joined together as a chain by inserting the free extremity of a first lamp into the single recess of a protective cap. By under sizing the protective cap relative to the free extremity of the lamp and by selecting a sufficiently flexible material the protective cap may be fitted onto the free extremity by push-fitting the free extremity into the protective cap. The elasticity of the cap would cause the cap to be retained in position. The side of the protective cap with the plurality of electrical contact point receiving recesses may be used to secure a first lamp to a second lamp. The electrical contact point receiving portions may incorporate a chamfer to facilitate the location of the electrical contact points into the recesses. The recesses may be undersized relative to the diameter of the electrical contact point projections in order to form a tight fit between the first and second lamp. A plurality of lamps may be joined in this manner prior to feeding into a coating station. A number of guide pulleys may be provided in order to assist in guiding the lamps to a series of caterpillar belts which may be individually driven by a DC motor via a timing belt drive and a transmission gear box.

The caterpillar belts may be located against an extruder station in which coating material is applied. The extruder may comprise a vacuum hopper loader from which solid polymeric material usually in the form of pellets is passed through to the extruder itself. The extruder itself may be mounted at 90 degrees to the line along which the lamps pass. In the extruder, the polymeric material is plasticized before being passed to a cross-head. The amount of material passing out of the extruder and the rate of the caterpillar belts is synchronised to ensure that the same mass of Polymer per unit length of tubing is applied at the various line speeds at which the apparatus can operate.

A tool fitted under the cross-head has a sufficient diameter in order to allow the lamps to pass. An air knife may be provided to cool the coating and the lamp tubes once the coating has been applied. A cutting saw comprising a rotating knife mounted inside a large ball-race may be used to separate the tubes from one another. Linkage members remain in position as the coating extends over the lamp and around at least a portion of the linkage member as shown in FIG. 6. FIG. 6 shows a coating layer 27 which overlaps the lamp and extends over the protective cap upto approximately the chamfer line 28 of the protective cap. The protective cap stays on the lamp during its life cycle. Using this method it is expected to achieve from 2 to 15 metres per minute of production.

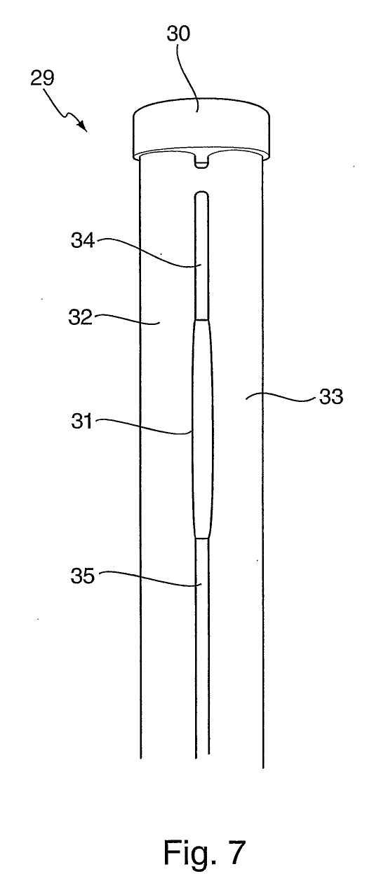

FIG. 7 shows a lamp 29 with a protective end cap 30. Although not shown for simplicity, the lamp would be coated as described previously. A support member 31 located between tube 32 and 33 is provided. Support member 31 is located in a portion of the gap which is provided between the adjacent tubes. The support member extends longitudinally to a length which corresponds in this illustrative embodiment to approximately five times the length of the cap 30. Gap portion 34 and 35 are without any support member. The support member may take the form of filler made of any appropriate material. Preferably, the material chosen may be relatively flexible. It may for example be silicon based. In one preferred form, it may be of silicon rubber.

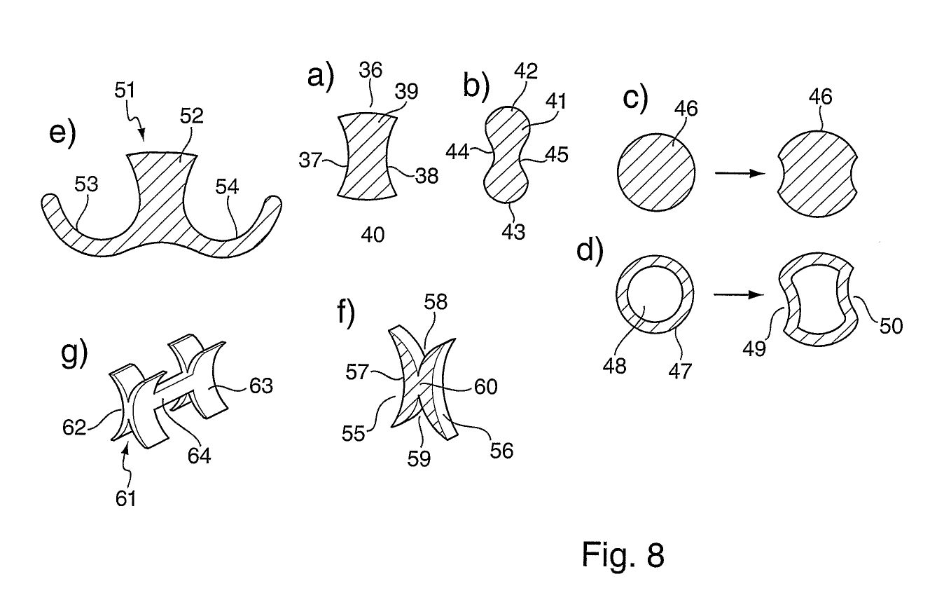

FIG. 8 shows support members in accordance with a plurality of individually inventive configurations. FIG. 8a shows in cross-section a support member 36 shaped and configured to fit in the gap between two lamp tubes. Support member 36 incorporates two inwardly bowed side faces 37 and 38 for fitting against inside portions of tubes. The wider upper and lower portions 39 and 40 serve to retain the support member in position.

FIG. 8b shows a support member 41 with an upper and lower convex faces 42 and 43. The support member of FIG. 8b also incorporates inwardly bowed side faces 44 and 45 in a similar fashion to FIG. 8a allowing the support member to tightly fit between tubes of a lamp.

FIG. 8c shows a support member 46 which is inherently flexible so that it may initially be circular in cross-section and then deform when placed between the tubes of a lamp as indicated by the second view of support member 4b. Support member 4b may be filled of material throughout.

FIG. 8d shows by contrast a support member 47 which incorporates a hollow portion 48 allowing the support member to readily flex into its supporting position as shown in the section view of FIG. 8d. In its supporting configuration, support member 47 incorporates two inwardly bowed faces 49 and 50.

Whilst FIGS. 8a to 8d primarily show support members which would be placed interstitially, FIG. 8e shows a support member 51 with a portion 52 for fitting in the gap between tubes and two laterally extending portions 53 and 54 which may be placed around the tubes. In this manner, the tubes would be covered in the supporting area in excess of about two thirds of the circumference of the tubes. Due to the relative thickness of portion 52 and of laterally extending portions 53 and 54, portions 53 and 54 will tend to readily bend in order to allow the supporting member to clip on to the lamp.

FIG. 8f shows a support member 55 with two bowed lateral portions 56 and 57 shaped and configured to correspond to the inward portion of a lamp between its tubes. Indentations 58 and 59 are provided in the upper and lower portions of the support member. In one preferred embodiment the indentations are V-shaped. Support member 55 is formed essentially from two truncated cylinders attached at their outer circumference over a portion 60.

FIG. 8g shows a further improvement on the embodiment of FIG. 8f where the support member 61 incorporates two portions 62 and 63 which are of similar configuration to support member 55 whilst being spaced apart by linkage member 64.

1. A linkage member to link lamps; said lamps being of the kind which comprise electrical contact points located at their first end and no external electrical contact points at their second end; said linkage member comprising a first portion configured to attach to the electrical contact points of a first lamp and to cover at least in part said electrical contact points; and a second portion configured to connect to a second lamp at an end which has no external electrical contact points.

2. A linkage member according to claim 1, wherein said first portion incorporates at least one recess configured to tightly fit onto at least one electrical contact points formed as projections.

3. A linkage member according to claim 1, wherein said second portion incorporates at least one recess configured to tightly fit onto a second lamp at an end which has no external electrical contact points.

4. A linkage member according to claim 1, which is shaped and configured to connect two PLL lamps by push-fit means.

5. A linkage member according to claim 4, wherein said second portion incorporates two recesses which are shaped and configured to receive the two tube ends of a PLL lamp.

6. A linkage member according to claim 1, which is inherently flexible in order to be secured to a variety of lamp sizes.

7. A method of protecting lamps comprising the steps of linking a succession of lamps being of the kind which comprise electrical contact points located at their first end and no external electrical contact points at their second end by placing one or more linkage members according to claim 1 between lamps; submitting said lamps to a station for the application of a shatter resistant or containing protective layer of material; separating adjacent lamps after application of said protective layer of material; and retaining said linkage member on the second end of said lamps.

8. A method according to claim 7, wherein said lamps incorporate at least two adjacent tubes with at least one gap between said tubes and said method further comprises the step of placing a support member in at least a portion of said gaps between said tubes.

9. A lamp comprising electrical contact points located at its first end and no external electrical contact points at its second end; a shatter resistant or containing protective layer of material enveloping said lamp; and a protective cap which is connected to the end of the lamp which has no external electrical contact points; wherein said protective layer extends at least over a portion of said protective cap.

10. A lamp according to claim 9, wherein said lamp incorporates at least two adjacent tubes with at least one gap between said tubes and a support member is provided between at least two tubes in at least a portion of said gaps.

11-13. (canceled)
